(19) United States
(12) Patent Application Publication
(10) Pub. No.: US 2013/0046701 A1
(43) Pub. Date: Feb. 21, 2013

(54) INTEGRATED BUILDING MANAGEMENT SYSTEMS

(71) Applicant: Richard P. PALMERI, N. Palm Beach, FL (US)

(72) Inventor: Richard P. PALMERI, N. Palm Beach, FL (US)

(21) Appl. No.: 13/587,213

(22) Filed: Aug. 16, 2012

Related U.S. Application Data
(60) Provisional application No. 61/523,890, filed on Aug. 16, 2011.

(51) Int. Cl. G06Q 99/00

(52) U.S. Cl. 705/317

(57) ABSTRACT

A system for the coordinated collection of information related to a potentially hazardous condition, within a specific venue, from a community of interested entities, the comparison of such information against a set of generally accepted criteria for control and containment of a potentially hazardous condition, and the rating of the specific environment, as to safety and as to the risk associated with the potentially hazardous condition via-a-vis the specific structural environment within which it exists. This system can also do prediction analysis and therefore extrapolate solutions to impending problems. This can lead to systems of mitigation and or apply methods and means of life safety such as evacuation plans, preparation plans, etc., since understanding structural integrity is related to how much time a first responder or occupant may have before a building collapse based on specific conditions.

### CROSS-REFERENCE TO RELATED APPLICATIONS

This application claims priority to U.S. Provisional Patent Application No. 61/523,890, filed Aug. 16, 2011 and entitled “INTEGRATED BUILDING MANAGEMENT SYSTEMS”, the contents of which are hereby incorporated by reference in their entirety.

### BACKGROUND OF THE INVENTION

1. Field of the Invention

This invention relates to a system and to a method. More specifically, this invention relates to a system and method for identification and control of an inventory of potentially known and unknown hazardous conditions and/or substances may occur or be within any given building and the immediate environment thereto, in order to provide an awareness of materials and most or all conditions that can contribute to a loss of life and or property and thereby affect the building, it occupants, the first responders and or the community around said building. The essential premise of this patent is to provide the necessary technology; sensors, cameras, information and or architectural plans, structural plans, building content data as well as a computer based software capable of interpolating information and or communicating information to insurance companies, first responders and others authorized to receive said information.

2. Description of the Prior Art

The prior art is replete with various systems and protocols for maintaining an audit trail for hazardous material, (U.S. Pat. No. 6,122,622—to Witala et al, issued Sep. 19, 2000); for assessment and management of a security system (U.S. Pat. No. 7,920,275—to Baudin et al, issued October 2007); for hazardous substance tracking and compliance with regulatory reporting requirements (U.S. Pat. No. 5,726,884—to Strugeon et al., issued Mar. 10, 1998); for continuous monitoring of a multiple environments for anomalies and responding as appropriate, (U.S. Pat. No. 7,049,953—to Kulesz et al, issued May 23, 2006); for provision of a data base of information to assist responders in dealing with an emergency, (U.S. Pat. No. 7,280,038—to Robinson, issued Oct. 9, 2007); and, for training of personnel in their response to a hazardous incident, (U.S. Pat. No. 7,194,395—to Genovese, issued Mar. 20, 2007).

In each of the foregoing, there is recognition that in dealing with hazardous substances and dangerous conditions, a responder or regulator requires both information relative to the substance and/or condition, and the environment in which the substance and/or condition is to be found. Moreover, an effective system for dealing with a hazardous substance also requires some initial control over the containment or storage within a specific environment, “in-place” precautions to deal with an out of control event, involving such substance and/or condition, and an action plan in the event of an emergency.

At present, all of the foregoing systems, protocols and training are inadequate, either because there are no standard or acceptable protocols or standard operating procedures, or process for a risk assessment, and the responsibility for advance planning, and the response to an emergency, are both uncoordinated and decentralized. More specifically, none of the foregoing systems and protocols provide for both (a) advance identification, by location, of potentially hazardous conditions or materials, within a specific venue, (b) creating a manifest or an inventory of such potentially hazardous conditions and material within such venue, (c) updating changes in the manifest or in the inventory of such potentially hazardous conditions and material in such venue, and (d) the status of such potentially hazardous conditions and materials in such venue, in the event of a natural or man-made disaster, (e.g. fire, earthquake, flood, structural instability, etc.). The absence of such risk assessment system, or systems, intelligence or hardware allowing advance notice and “intelligence” to be held, computed and or broadcast can and will save property and or lives.

The problems associated with risk assessment are further compounded by variation in the venue architecture, structural composition and or content and the condition or materials present; and, the proximity of such venue to other areas that may be exposed to the risk created by such condition or materials. For example, where volatile chemicals are stored within a relatively closed area within a building, and this closed area is poorly ventilated, the volatiles can become fairly concentrated, and potentially more dangerous than if they were stored in an alternate manner.

### SUMMARY

It is the object of this invention to remedy the above, as well as related deficiencies in the prior art, More specifically, it is the principle object of this invention to provide a method and system for identification of a potentially hazardous conditions, of material, people, or other within a specific venue, and that the provision of information relative to such hazardous or dangerous conditions can be communicated to a risk assessment data base, which is accessible to a community of interests.

It is another the object of this invention to provide a method and system for identification of a potentially hazardous conditions, within specific venues, and the provision of information relative to such hazardous conditions to a risk assessment data base, so as to provide a rating or scoring of the potential risk or hazard for insurance underwriting purposes. It is yet another object of this invention to provide a method and system for identification of a potentially hazardous conditions, within specific venue, and the provision of information relative to such hazardous condition to a risk assessment data base, so as to provide emergency responders an awareness of the venue specific controls and precaution in place (if any) for control and containment of a hazardous condition at such specific venue.

It is still yet another object of this invention to provide a method and system for identification of a potentially hazardous condition, within specific venue, and the provision of information relative to such hazardous condition to a risk assessment data base, so as to provide emergency responders awareness of the equipment and response needed to control a hazardous condition at such specific venue.

Additional objects of this invention may also include a software package or series of software and hardware responses as a “servo” in order to react and or help in the coordinate the information collection from a community of interest, in the identification of a potentially hazardous conditions within a specific venue, the structural environment of the specific venue within which the potentially hazardous condition exists and the in-place controls within the environment of the specific venue for the containment and/or control of the potentially hazardous condition and sensed or anticipated condition.

The above and related objects are achieved by the provision of a system for the coordinated collection of information related to a potentially hazardous condition, within a specific venue, from a community of interested entities, the comparison of such information against a set of generally accepted criteria for control and containment of a potentially hazardous condition, and the rating of the specific environment, as to safety and as to the risk associated with the potentially hazardous condition via-a-vis the specific structural environment within which it exists. This system can also do prediction analysis and therefore extrapolate solutions to impending problems. This can lead to systems of mitigation and or apply methods and means of life safety such as evacuation plans, preparation plans etc. understanding structural integrity is knowing how much time a first responder or occupant may have before a building collapse based on specific conditions. The invention also contemplates digital drawings and or real time photography that can assist first responders to understand the building or environment and therefore deal with the conditions based on knowledge not guess work.

No fireman or policeman should die because they do not have access to technology that can be put in place now. In one of the preferred embodiments of this invention, the community of interested entities includes the (a) owner and/or occupant of a building (office building or warehouse); (b) the private or governmental agency charged with the compliance of the building and/or the building occupants to regulations relating to fire safety equipment and/or the handling and storage of materials that are potentially noxious or flammable; (c) the insurance company underwriter which, through loss experience and/or its own testing programs, has its own set of criteria for risk assessment and control; and (d) emergency response personnel who need advance warning or information as to the building structure, the location of emergency support equipment (e.g. fire hose connections) within the building, a manifest of the building contents and the proximity of the specific venue to other vulnerable buildings within the vicinity.

### BRIEF DESCRIPTION OF THE DRAWINGS

FIG. 1 is a flow chart of the overall organization of the system of this invention.

FIG. 2 is an expanded flow chart of the information collection of the building owner/occupant, including specifically, the development of a manifest of potentially hazardous materials located within the building.

FIG. 3 is an expanded flow chart of the controls and regulatory compliance criteria for a building having the manifest of potentially hazardous material set forth in FIG. 2.

FIG. 4 is an expanded flow chart of an emergency responder capability for control and containment of a potentially hazardous condition in the building of FIG. 2.

FIG. 5 is an expanded flow chart of the insurance underwriter criteria for the risk assessment of a building having the manifest of potentially hazardous materials set forth in FIG. 2, including a safety rating of the building of FIG. 2.

FIG. 6 is a flow chart of the operation of the interactive system of this invention.

FIG. 7 is a flow chart of the interactive access of the system of FIG. 1 by the building owner/occupant of the building of FIG. 1.

FIG. 8 is a flow chart of the interactive access of the system of FIG. 1 by the entity responsible for compliance of the building of FIG. 1 with regulations governing the safety of the building and/or the contents of the building.

FIG. 9 is a flow chart of the interactive access of the system of FIG. 1 by the emergency responders, including any update in emergency responder capability and equipment, and, the use of the system to confirm the appropriate equipment and materials needed to contain and abate the hazardous condition within the building.

FIG. 10 is the flow chart of the interactive access of the system of FIG. 1 by the underwriter of the insurance company, to confirm the compliance of the building with the regulations governing the safety of the building and the manifest of its content, including any adjustment in the building's safety rating.

FIG. 11 is a flowchart illustrating safe and secure structures that communicate vital information.

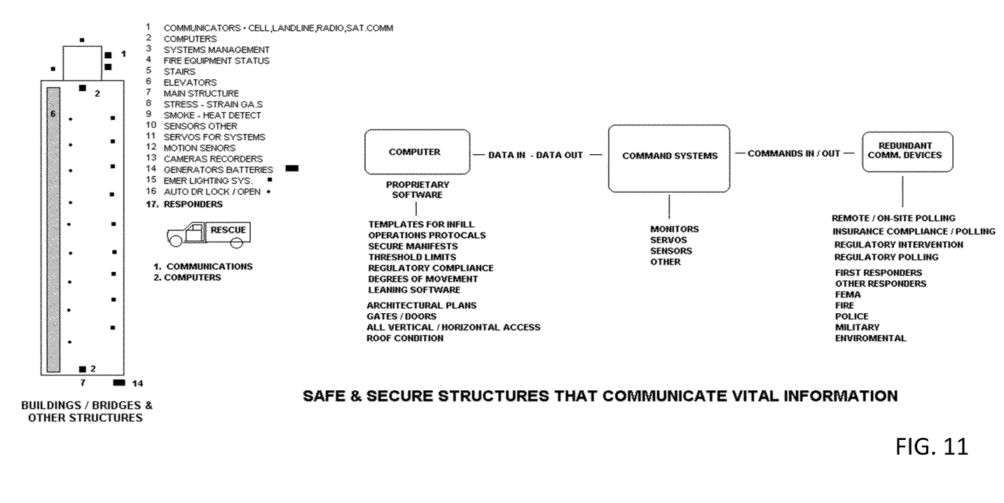

FIG. 12 is a schematic of a computing system that can be configured to implement the systems and methods of the various embodiments.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

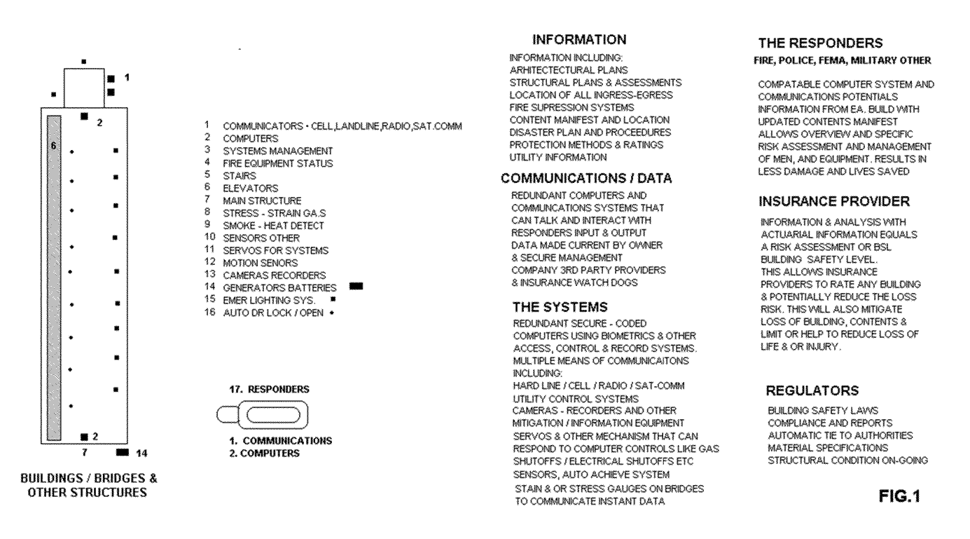

FIG. 1 depicts the overall organization of a system of this invention, based upon a community of interests in the safety of a specific building. Each member of this community contributes information, based upon its own area of expertise, to a data pool, which, in turn, organizes and evaluates this data, based upon a set of criteria, and thereby creates a safety rating for a specific building and its contents.

This system provides limited access to the data pool, based upon an interested party's expertise and interests, to periodically review the building safety rating and/or to update its own contribution to the data pool with additional or revised information.

Although the various embodiments will be described with respect to a building, the various embodiments are equally applicable to any structure built on land or any type of boat or ship, such as a military vessel, a governmental vessel, a passenger vessel, or a commercial vessel. Additionally, the various embodiments can be equally applicable to other type of land-based, sea-based, or air/space-based structures or vehicles.

System Set-Up & Configuration

This process is initiated by an information collection process from each member of the community of interest with respect to a particular building or venue.

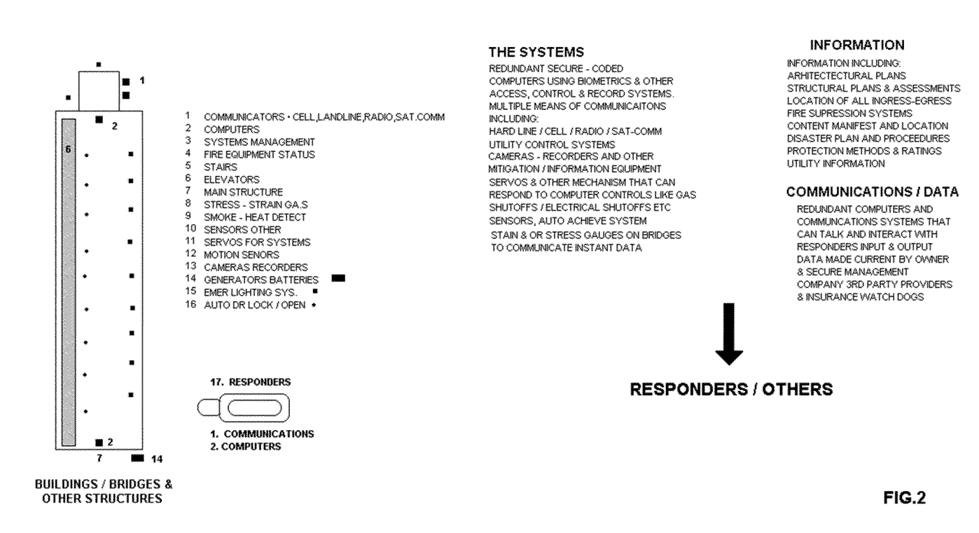

FIG. 2 illustrates flow diagram for the compilation of the information applicable to the building owner and building occupant of the system depicted in FIG. 1. The information packet provided to the data pool by the building owner and/or its occupant includes the basic construction and engineering details for the building, the nature of the occupant/tenant business, the equipment and materials associated with the operation and maintenance of the occupant/tenant business, the number of building occupants and their location within the building, and the hours of operation of each business in the building. This packet of information is collectively referred to as the “Building Manifest”. The owner and/or occupant has responsibility for periodic updating of the Building Manifest, which can be calendared on or before the date of renewal of the building owner and/or occupant renewal of its liability and/or property damage insurance policy.

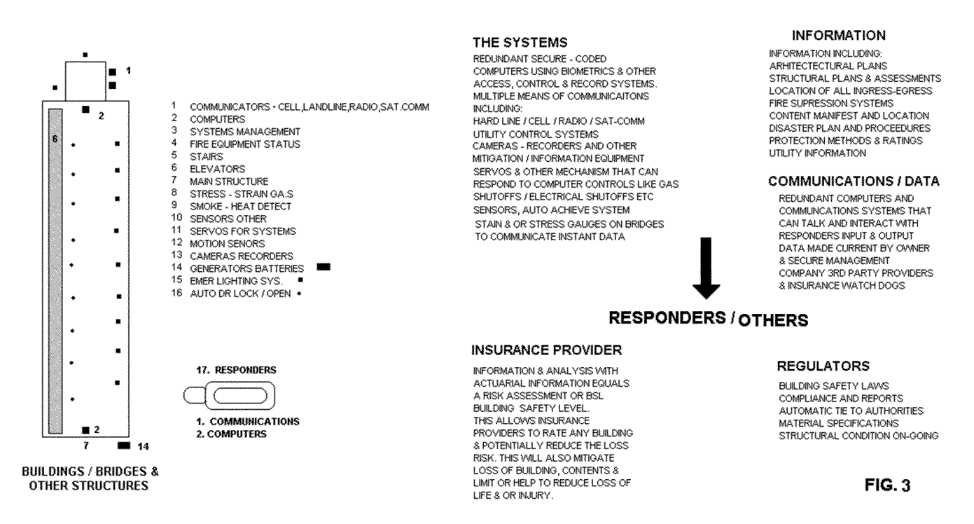

FIG. 3 illustrates an expanded flow diagram for the compilation of information relative to applicable regulatory criteria of the governmental and/or private agency, applicable to the building owner and building occupant of the system depicted in FIG. 1. In for example, a manufacturing environment, comprising a single occupants or tenant, and/or multiple occupants and tenants, the applicable regulatory criteria for ventilation, waste storage and disposal, power supplies, and worker protection would be identified for the applicable regulation, for each of occupant of the building; and, a compliance audit maintained and updated on the system for each item within the Building Manifest. Any changes to the applicable regulatory criteria would be periodically added and/or revised with respect to this component of the data pool.

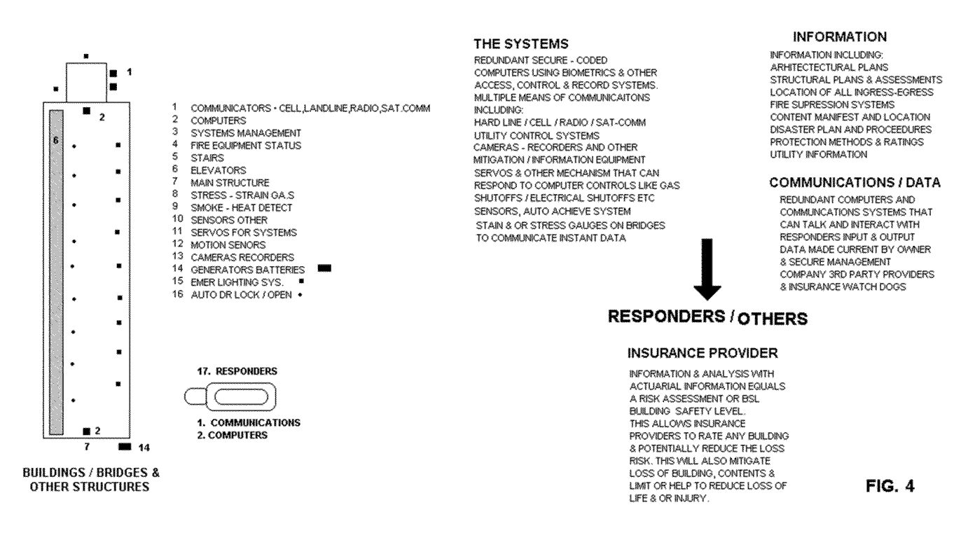

FIG. 4 is an expanded flow diagram for the compilation of information relative to an emergency responder capability for control and containment of a potentially hazardous conditions in the system depicted in FIG. 1. The emergency responder, typically the fire or police department, Department of Homeland Security, etc, having proximity to the building, and jurisdiction for the specific hazardous condition, e.g. fire, toxic chemical spill, radioactive materials, etc., would be identified The emergency responder would also identify its capability and approximate response time and other factors in its arsenal, for dealing with different hazardous conditions. Where for example where there was a biohazard, the governmental agency or agencies having the capability of control and containment of bio hazardous materials would have primary responsibility and coordinate the response of other supporting entities.

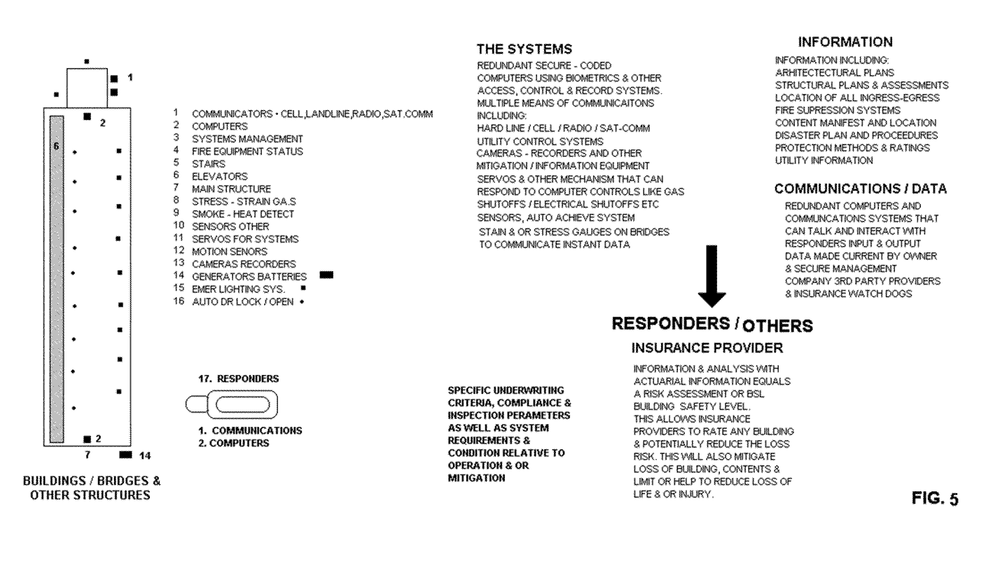

FIG. 5 an expanded flow diagram for the compilation of information relative to insurance underwriter loss experience, applicable to the building owner and/or building occupant of the system depicted in FIG. 1. In this illustration, the data from the building owner and/or occupant, (Building Manifest), and applicable regulatory criteria, is subjected to a loss experience analysis, or risk assessment, by the insurance company and the underwriter generates a “safe building rating”, for example, a rating of “10” be the safest or highest rating a building could attain, and the rating of “1” the lowest rating a building could attain and still be insurable. This rating would, thus, not only include the factors which are intrinsic to the building, the Building Manifest, the applicable regulatory compliance factors, but also the proximity to the nearest fire station, and the emergency responder capacity to deal with a hazardous condition in the building.

Community of Interest Interactions

Once the system has been initially configured, as set forth above, and put in place any member of the community of interest would have access to the system to review the status and Safe Building Rating of the building. The configuration of the system permits limited access of each member of the community of interest to access its own data within the data pool, to update and revise the information previously supplied by it.

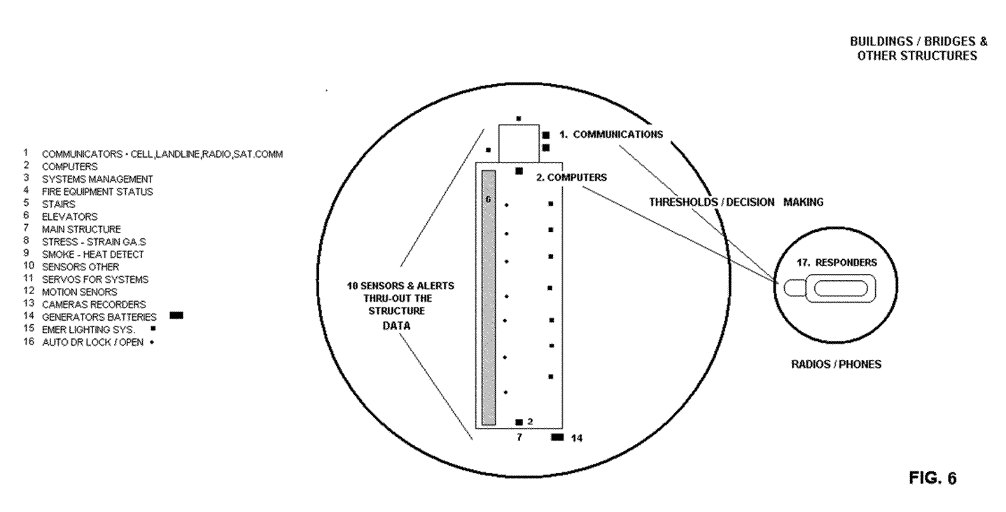

FIG. 6 illustrates the operation of the interactions of the various members of the community of interest in the building, relative to one another, in response to changes in one or more of the data of an individual member of the community of interest.

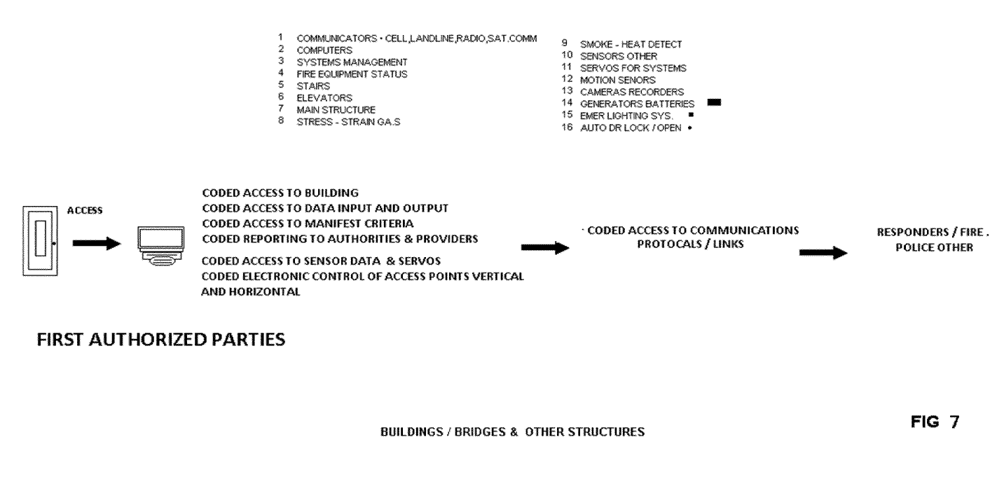

FIG. 7 is an expanded diagram of the changes in the Building Manifest where, for example, the building owner or occupant changes the use of the building, from a warehouse to a manufacturing facility. Under these circumstances, a series of alerts would be generated, advising other members of the community of interest of a substantive change in the Building Manifest, and, accordingly, the need for a corresponding re-evaluation of the Safe Building Rating.

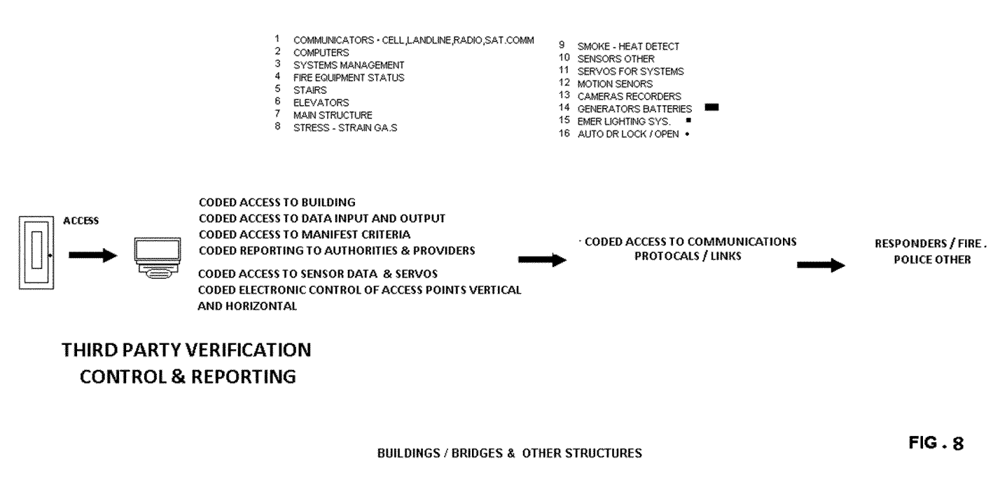

FIG. 8 is an expanded diagram of the changes in the regulatory compliance profile of the building, where, for example, the entity responsible for regulatory compliance of the building owner or occupant requires additional precautions for the use, disposal and/or storage of potentially toxic or flammable materials. Under these circumstances, a series of alerts would be generated, advising other members of the community of interest of a substantive change in the building use, and, accordingly, the need for a corresponding re-evaluation of the Safe Building Rating.

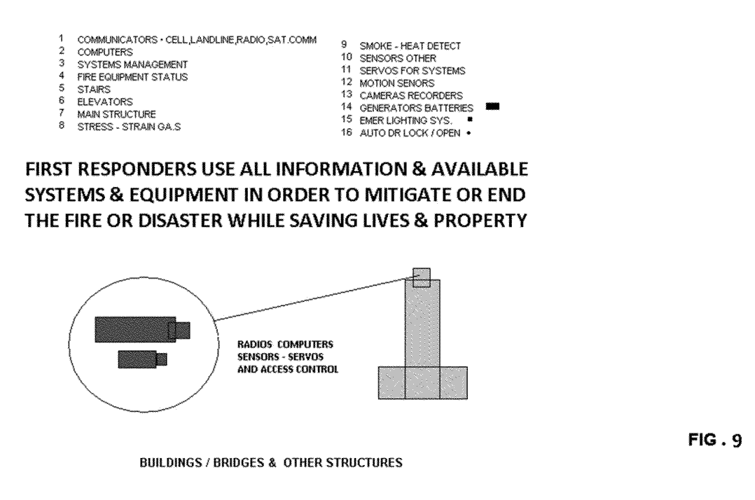

FIG. 9 is an expanded diagram of the changes in emergency responder profile of the building, where, for example, the emergency responder capability and equipment, needed to contain and abate the hazardous condition within the building, substantially changes. Under these circumstances, such changes (e.g. the closing of a fire station in proximity to the building and/or the reduction in force of the fire fighter personnel), change the estimated response time and capability of the emergency responder, to respond to a potentially hazardous condition or substance. These substantive changes in the emergency responder capabilities generate a series of alerts, advising other members of the community of interest of the need for a corresponding re-evaluation of the Safe Building Rating.

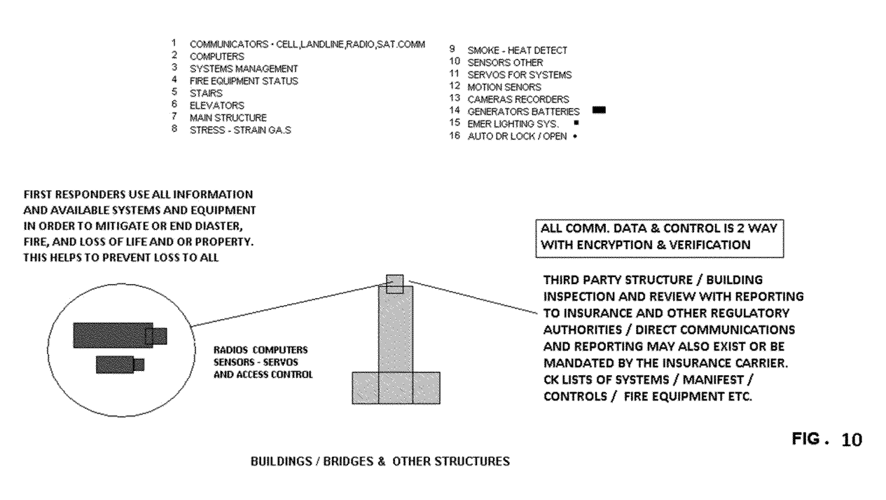

FIG. 10 is an expanded diagram of the changes in the Safe Building rating of the building the underwriter of the insurance company, as a result of the insurance underwriter making a reassessment of the risk posed by the potentially hazardous condition or materials, based upon changes in the Building Manifest, changes in the regulatory compliance data profile and/or changes in the emergency responder data profile data profile.

The disclosed system includes the following features:

1. An interactive system for the coordinated collection of information related to a existing or engaged problem or hazardous condition, within a specific venue, from a group of entities/sensors technology having a community of interest in a specific venue, comprising:

A. Providing an interactive computer based system for connection of a group of entities having a community of interest in a specific venue;

B. Means for creating, within an interactive computer based system, a building manifest for a specific venue based upon (a) structural and engineering characteristics of said building, (b) use of said building, (c) potentially hazardous materials that are present in said building and (d) location and number of occupants in said building;

C. Means for creating, within said interactive computer based system, a data profile of regulatory compliance criteria for said building based upon said building manifest and or profile and other relevant data in said computer based system;

D. Means for creating, within said interactive computer based system, a data profile of an emergency responder for said building, based upon said building manifest and other relevant data in said computer based system;

E. Means for creating, within said interactive computer based system, a safe building rating, by a risk assessment of said building manifest and other relevant data within said computer based system, for use by one or more members of said group of said entities having a community of interest in said venue.

2. The interactive system of paragraph 1 above, wherein said emergency responder has access to said interactive system before or during response to an emergency alert at said venue. All data shall be coded, date stamped, verified. The invention herein also contemplates the use of a biometric system of access and or reporting to insure that only authorized individuals are accessing the “system” and or altering any of the date therein. Said biometric can also be applied to first responders through a simple enrollment system with emergency override.

3. The interactive system of paragraph 1 above, wherein said risk assessment personnel has access to said interactive system in determining a risk of loss from a hazardous condition or substances within said venue.

4. The interactive system of paragraph 1 above, wherein said regulatory compliance personnel have access to said interactive system in determining compliance with national or local protocols.

5. The interactive system of paragraph 1 above, wherein a member of said group of entities, having a community of interest in said venue, periodically updates and revises said data profile of said member to reflect changes in said building manifest, said regulatory compliance criteria or said risk assessment, upon changes.

6. An interactive data processing routine, for execution on a computer network, comprising:

A. A data base module which includes architecture for storing a plurality of discrete data profiles from a group of entities having a community of interest in a specific venue, said data profiles including a building manifest for said venue, a regulatory compliance data profile for said venue, and emergency responder data profile for said specific venue; a risk assessment data profile, which includes empirical or statistical data reflecting risk of loss, by comparison of said manifest against said data in said data base;

B. Means for permitting limited access to each of said discrete data profiles to said entity corresponding to said data profile, to edit, revise and/or supplement said data profile corresponding to said entity; and

C. Means for deriving a safe level of operation based on systems applied to any given building venue rating for said venue from assessment of said risk of loss, based upon comparison of said manifest against said data in said data base.

All potentially hazardous conditions, within a specific venue, from a community of interested entities, the comparison of such information against a set of generally accepted criteria for control and containment of a potentially hazardous condition, and the rating of the specific environment, as to safety and as to the risk associated with the potentially hazardous condition via-a-vis the specific structural environment within which it exists.

The invention clearly calls for both on-site and offsite programmable and storable data and commands for any given building or environment.

Overview of Risks Associated with Multiple Occupancy Structures and the Benefits of “Safe Building” to Public Safety Agencies and First Responders

Multiple occupancy buildings present a variety of challenges to public safety agencies. Life safety and code enforcement are the primary responsibilities of these agencies and are affected by the use (occupancy), floor plan and non-structural hazards. Safe Building offers public safety agencies prompt access to current structural and non-structural building information to prevent loss of life, injury and more efficient execution of code enforcement activities.

Public safety agencies prioritize activities using as follows: Life Safety, Incident Stabilization, and Property Conservation. Life Safety, the protection and preservation of human life, is the primary responsibility of any public safety agency. This mission is accomplished through the enforcement of laws, statutes, ordinances and codes regulating the construction, installed systems and use of buildings. Incident Stabilization, the mitigation of events, is greatly affected by the construction, modifications made, and use of these buildings. Property Conservation, limiting the effects of fire, water, smoke, and structural damage resulting from incidents involving these buildings, is affected by agencies' ability to conduct thorough code enforcement activities and have prompt access to building information.

Multiple-occupancy buildings pose a significant risk to the proper execution of activities conducted by public safety agencies. This risk is most commonly the result of insufficient or inaccurate building information:

Modifications to floor plans

Dynamic building contents

Changes is use

Changes in occupancy (census)

Improper or insufficient maintenance (structure, systems, finishes) Agencies frequently lack sufficient code enforcement personnel to effectively monitor the myriad information required to ensure the safety of these buildings for occupants and first responders.

Open floor plan buildings present enormous challenges to first responders. This layout is designed to easily accept modifications to meet the needs of the occupant. As needs or occupants change so, in many cases, does the layout of interior (non-structural) finishes and contents change.

Desks, moveable partitions, manufacturing equipment and products present significant risks to life safety if information is not current or improperly documented. Occupants and firefighters can become lost in unfamiliar or unknown maze-like office settings. Flexible layouts provide ready cover for criminals evading law enforcement unfamiliar with the setting.

‘Safe Building’ provides public safety with immediate access to current floor plans, manifests and occupancy information. Operators entering the structure can review building information prior to entry and layout information can be transmitted from a communications or command center during interior operations. Areas of refuge or evacuation instructions can be relayed to building occupants to prevent unnecessary injuries or loss of life.

Code enforcement activities are historically resource intensive due to the direct nature of the process. Building and fire code enforcement officials must visit occupancies annually and each time changes are made. Agencies are most frequently task rich and resource poor, limiting the proper execution of inspection and enforcement efforts. Changes to floor plans, building hazards and occupancy types can go unnoticed for years presenting risks to life safety and increasing jurisdictional liability. Incomplete, improper or failed inspection and enforcement activities have resulted in large settlements and punitive awards.

Safe Building provides code enforcement officials with current information relevant to the inspection and enforcement process. Officials can access building information remotely to review changes, manifests and occupancy information. Verification and enforcement can be conducted in-person as needed. Safe Building, therefore, increases the scope and effectiveness of inspection and enforcement activities by improving access to essential information and use of limited human resources.

Safe Building is revolutionary in its concept and design. Current and accurate information is essential to safe and effective public safety operations. Manual activities to gather, assimilate and render useful similar types of information are sufficiently costly and impractical to be prohibitive. Building owners, occupants, public safety agencies and jurisdictional authorities will certainly realize the value of this product to life safety, incident management, code enforcement and fiscal controls.

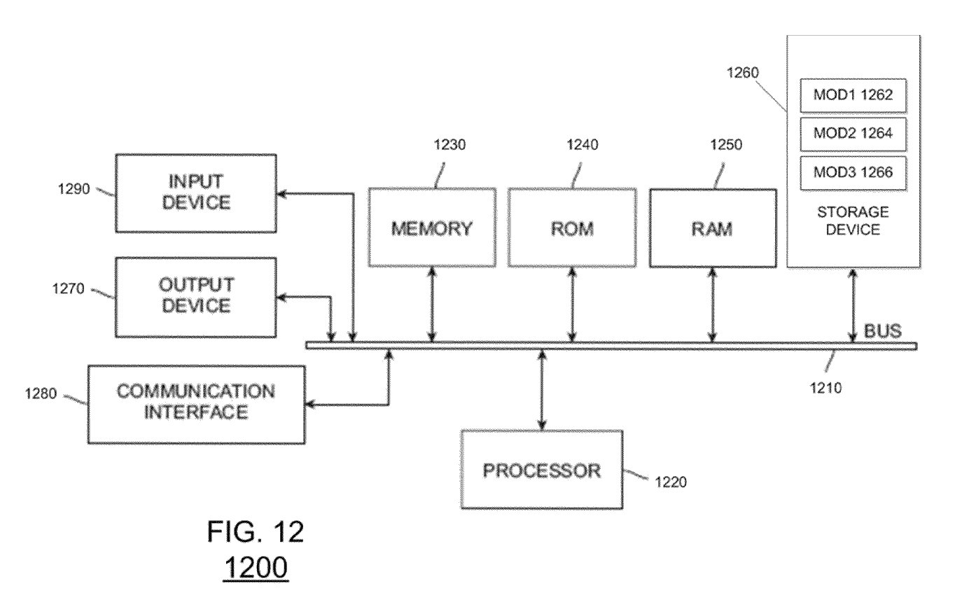

FIG. 12 illustrates an exemplary system 1200 that includes a general-purpose computing device 1200 for implementing any of the systems and methods described above. System 1200 includes a processing unit (CPU or processor) 1220 and a system bus 1210 that couples various system components including the system memory 1230, such as read only memory (ROM) 1240, and random access memory (RAM) 1250 to the processor 1220. The system 1200 can include a cache 1222 of high speed memory connected directly with, in close proximity to, or integrated as part of the processor 1220. The system 1200 copies data from the memory 1230 and/or the storage device 1260 to the cache 1222 for quick access by the processor 1220. In this way, the cache 1222 provides a performance boost that avoids processor 1220 delays while waiting for data. These and other modules can control or be configured to control the processor 1220 to perform various actions. Other system memory 1230 may be available for use as well. The memory 1230 can include multiple different types of memory with different performance characteristics. It can be appreciated that the disclosure may operate on a computing device 1200 with more than one processor 1220 or on a group or cluster of computing devices networked together to provide greater processing capability. The processor 1220 can include any general purpose processor and a hardware module or software module, such as module 12 1262, module 2 1264, and module 3 1266 stored in storage device 1260, configured to control the processor 1220 as well as a special-purpose processor where software instructions are incorporated into the actual processor design. The processor 1220 may essentially be a completely self-contained computing system, containing multiple cores or processors, a bus, memory controller, cache, etc. A multi-core processor may be symmetric or asymmetric.

The system bus 1210 may be any of several types of bus structures including a memory bus or memory controller, a peripheral bus, and a local bus using any of a variety of bus architectures. A basic input/output (BIOS) stored in ROM 1240 or the like, may provide the basic routine that helps to transfer information between elements within the computing device 1200, such as during start-up. The computing device 1200 further includes storage devices 1260 such as a hard disk drive, a magnetic disk drive, an optical disk drive, tape drive or the like. The storage device 1260 can include software modules MOD1 1262, MOD2 1264, MOD3 1266 for controlling the processor 1220. Other hardware or software modules are contemplated. The storage device 1260 is connected to the system bus 1210 by a drive interface. The drives and the associated computer-readable storage media provide nonvolatile storage of computer readable instructions, data structures, program modules and other data for the computing device 1200. In one aspect, a hardware module that performs a particular function includes the software component stored in a non-transitory computer-readable medium in connection with the necessary hardware components, such as the processor 1220, bus 1210, output device 1270, and so forth, to carry out the function. The basic components are known to those of skill in the art and appropriate variations are contemplated depending on the type of device, such as whether the device 1200 is a small, handheld computing device, a desktop computer, or a computer server.

Although the exemplary embodiment described herein employs a hard disk as storage device 1260, it should be appreciated by those skilled in the art that other types of computer-readable media which can store data that are accessible by a computer, such as magnetic cassettes, flash memory cards, digital versatile disks, cartridges, random access memories (RAMs) 1250, read only memory (ROM) 1240, a cable or wireless signal containing a bit stream and the like, may also be used in the exemplary operating environment. Non-transitory computer-readable storage media expressly exclude media such as energy, carrier signals, electromagnetic waves, and signals per se. However, non-transitory computer-readable storage media do include computer-readable storage media that store data only for short periods of time and/or only in the presence of power (e.g., register memory, processor cache, and Random Access Memory (RAM) devices).

To enable user interaction with the computing device 1200, an input device 1290 represents any number of input mechanisms, such as a microphone for speech, a touch-sensitive screen for gesture or graphical input, keyboard, mouse, motion input, speech and so forth. An output device 1270 can also be one or more of a number of output mechanisms known to those of skill in the art. In some instances, multimodal systems enable a user to provide multiple types of input to communicate with the computing device 1200. The communications interface 1280 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 1220. The functions these blocks represent may be provided through the use of either shared or dedicated hardware, including, but not limited to, hardware capable of executing software and hardware, such as a processor 1220, that is purpose-built to operate as an equivalent to software executing on a general purpose processor. For example, the functions of one or more processors presented in FIG. 12 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 1240 for storing software performing the operations discussed below, and random access memory (RAM) 1250 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 1200 shown in FIG. 12 can practice all or part of the recited methods, can be a part of the recited systems, and/or can operate according to instructions in the recited non-transitory computer-readable storage media. Such logical operations can be implemented as modules configured to control the processor 1220 to perform particular functions according to the programming of the module. For example, FIG. 12 illustrates three modules MOD1 1262, MOD2 1264 and MOD3 1266, which are modules configured to control the processor 1220. These modules may be stored on the storage device 1260 and loaded into RAM 1250 or memory 1230 at runtime or may be stored as would be known in the art in other computer-readable memory locations.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

1-8. (canceled)

9. An interactive system for managing information associated with a structure, comprising:
a processor;
a computer-readable medium, having stored thereon a plurality of instructions for causing the processor to perform steps comprising:
receiving structure information from a plurality of entities associated with the structure, the structure information comprising physical characteristics of the structure, operational characteristics of the structure, and occupancy characteristics of the structure;
generating a manifest for the structure based on the structure information;
assembling a first data profile the structure regarding regulatory compliance based at least upon the manifest; and
computing at least one structure rating by virtue of a risk assessment analysis of the structure information based at least the first data profile.

10. The system of claim 9, wherein the steps further comprise:
receiving status information associated with one or more portions the structure, the status information comprising an operational status and an emergency status; and
creating a second data profile for at least one type of emergency responder based upon the manifest, the first data profile, the structure rating, and the status information.

11. The system of claim 10, wherein the second data profile comprises at least one of an identification of potential hazards in the structure, an identification of potential obstancles in the structure, or a recommendation of equipment for at least one type of emergency.

12. The system of claim 10, wherein the steps further comprise:
generating responder information for an emergency responder in a response to an emergency alert at said structure based on the second data profile.

13. The system of claim 9, further comprising a display at the structure, the display comprising at least one biometric system for limiting accessing to data records.

14. The system of claim 9, wherein the steps further comprise:
receiving at least one revision of the structure information; and
repeating the steps of generating, assembling, and computing.

15. The system of claim 9, wherein the physical characteristics comprise structural characteristics of the structure and engineering characteristics of the structure.

16. The system of claim 9, wherein the operational characteristics comprise a configuration of utilities within the structure, control systems for the structure, and security systems in the structure.

17. The system of claim 9, wherein the occupancy characteristics of the structure comprise a usage details for one or more portions of the structure, location and usage of potentially hazardous materials in the one or more portions of the structure and, a number of occupants associated with the one or more portions.

18. A method for managing information associated with a structure, comprising:
receiving structure information from a plurality of entities associated with the structure, the structure information comprising physical characteristics of the structure, operational characteristics of the structure, and occupancy characteristics of the structure;
generating a manifest for the structure based on the structure information;
assembling a first data profile the structure regarding regulatory compliance based at least upon the manifest; and
computing at least one structure rating by virtue of a risk assessment analysis of the structure information based at least the first data profile.

19. The method of claim 18, further comprising:
receiving status information associated with one or more portions the structure, the status information comprising an operational status and an emergency status; and
creating a second data profile for at least one type of emergency responder based upon the manifest, the first data profile, the structure rating, and the status information.

20. The method of claim 19, wherein the second data profile comprises at least one of an identification of potential hazards in the structure, an identification of potential obstancles in the structure, or a recommendation of equipment for at least one type of emergency.

21. The method of claim 19, further comprising:
generating responder information for an emergency responder in a response to an emergency alert at said structure based on the second data profile.

22. The method of claim 18, further comprising:
receiving at least one revision of the structure information; and
repeating the steps of generating, assembling, and computing.

23. The method of claim 18, wherein the physical characteristics comprise structural characteristics of the structure and engineering characteristics of the structure.

24. The method of claim 18, wherein the operational characteristics comprise a configuration of utilities within the structure, control systems for the structure, and security systems in the structure.

25. The method of claim 18, wherein the occupancy characteristics of the structure comprise a usage details for one or more portions of the structure, location and usage of potentially hazardous materials in the one or more portions of the structure and, a number of occupants associated with the one or more portions.

26. A non-transitory computer readable medium having stored therein a plurality of instruction for performing a method for managing information associated with a structure, the method comprising:
receiving structure information from a plurality of entities associated with the structure, the structure information comprising physical characteristics of the structure, operational characteristics of the structure, and occupancy characteristics of the structure;
generating a manifest for the structure based on the structure information;
assembling a first data profile the structure regarding regulatory compliance based at least upon the manifest; and
computing at least one structure rating by virtue of a risk assessment analysis of the structure information based at least the first data profile.
